(19) United States
(12) Patent Application Publication
(10) Pub. No.: US 2014/0108025 A1
(43) Pub. Date: Apr. 17, 2014

(54) COLLECTING AND TRANSFERRING PHYSIOLOGICAL DATA

(71) Applicants: Ruben Gerardo Echeverria Cabrera, Yucatan (MX); Hugo Luis Villalobos Canto, Van Nuys, CA (US); Luis Alberto Munoz Ubando, Yucatan (MX); Jose Ramon Atoche Ensenat, Yucatan (MX); Freddy Antonio Ix Andrade, Yucatan (MX); Alejandro Covalin Shaftman, Culiver, CA (US)

(72) Inventors: Ruben Gerardo Echeverria Cabrera, Yucatan (MX); Hugo Luis Villalobos Canto, Van Nuys, CA (US); Luis Alberto Munoz Ubando, Yucatan (MX); Jose Ramon Atoche Ensenat, Yucatan (MX); Freddy Antonio Ix Andrade, Yucatan (MX); Alejandro Covalin Shaftman, Culiver, CA (US)

(21) Appl. No.: 13/800,659

(22) Filed: Mar. 13, 2013

Related U.S. Application Data
(60) Provisional application No. 61/713,373, filed on Oct. 12, 2012.

(51) Int. Cl. G06F 19/00

(52) U.S. Cl. CPC G06F 19/3418
USPC 705/2

(57) ABSTRACT

The present invention extends to methods, systems, and computer program products for collecting and transferring physiological data. Different physiological monitoring appliances can be attached to a portable physiological data collection device. Each physiological monitoring appliance can collect a different physiological data (blood glucose data, heart rate data, etc.) from an individual. Different physiological data can be collected and stored at the portable physiological data collection device. In response to a triggering event, a connection can be established to an external computer system. The stored physiological data can be transferred over the established connection to the external computer system. In some embodiments, the external computer system is a healthcare server that shares collected physiological data as well as other healthcare information with designated entities (e.g., family, doctors, etc.). The healthcare server can share healthcare information in accordance with patient configured rules so that patients have control over dissemination their healthcare information.

### CROSS-REFERENCE TO RELATED APPLICATIONS

The present application claims the benefit of and priority to U.S. Provisional Application No. 61/713,373, entitled “Collecting and Transferring Physiological Data,” filed on Oct. 12, 2012, the entirety of which is incorporated herein by this reference.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some environments, electronic medical appliances are used to take physiological measurements for a patient. Patients with certain disease states, such as heart failure, diabetes, etc., are likely to own and use more than one of these medical appliances. These medical appliances include, but are not limited to, home blood pressure cuffs, pulse oximeters, heart rate monitors, blood glucose monitors, weight scales, and other appliances. The medical appliances can collect and temporarily store information, such as, for example, systolic and diastolic pressure, pulse rate, blood glucose levels, and patient weight.

Many electronic medical appliances include communication ports and software to connect them to a computer. As such, physiological information can be collected from multiple home medical devices and transferred to a computer. The physiological information is then available to both patients and their healthcare providers (e.g., via the Internet). In some systems, the patient must manually enter healthcare information data into appliances or websites, which can result in data entry errors. Additionally, some patients would prefer not to take the time to manually enter the healthcare information data, which can result in less complete data to treat and maintain the patient.

However, mechanisms for transferring physiological information to a computer can be cumbersome for a patient. The patient must have some level of technical competence to use the medical appliances, connect medical appliances to a computer, and utilize software to transfer physiological information to the computer. Individual medical appliances can also vary greatly in configuration, such as, data formats and communication protocols used to interface with a computer (even when the medical appliances are produced by the same manufacturer). Thus, a patient may need to have several different cables to connect to his or her computer and may also have to run different software to communicate with each different medical appliance.

For some patients there may also be a cost barrier. For example, a patient may not be able to afford a computer to store their physiological information.

There are also difficulties related to patient compliance. Since collected physiological information can indicate serious medical conditions, declining health, failure to take medication, etc., patients may be reluctant to use medical appliances to collect physiological information. If collected physiological information in fact indicates a medical difficulty, the patient may likewise be reluctant to transfer the physiological information to a computer for access by a healthcare provider. Thus, even if a patient has the correct equipment and technical competence, the patient may choose not to collect their physiological information or make that physiological information available to healthcare providers.

Additionally, due to the potentially significant level of human interaction with medical appliances, computers, and connections therebetween during the collection process, there is always the possibility for human error in the collection and/or transfer of physiological data.

In many environments, collected physiological data, as well as other types of healthcare information (e.g., prescription medicine data, medicine intake data, and electronic medical record data, etc.), is stored in electronic format on network computer systems. Although healthcare information is often stored electronically, healthcare information is typically available only to healthcare providers and only in pre-designated formats on an all-or-none basis.

Unfortunately, a patient typically has no way to efficiently control dissemination of his or her healthcare information. Further, patients have limited, if any, ability to compartmentalize the distribution of their healthcare information on a more granular level. Thus, a patient may have no way to send different parts of his or her healthcare information to different entities. For example, a patient typically has no way to make one portion of his or her healthcare information available to a family member and another different portion of his or her healthcare information available to a healthcare provider.

### BRIEF SUMMARY

The present invention extends to methods, systems, and computer program products for collecting and transferring physiological data. A portable physiological data collection device collects first physiological data from a first physiological monitoring appliance. The first physiological monitoring appliance communicatively couples (and may also mechanically and/or electrically couple) to an attachment port of the portable physiological data collection device. The first physiological monitoring appliance is selected from among a plurality of different physiological monitoring appliances configured for use with the A portable physiological data collection device. The first physiological data is stored at a storage device.

The portable physiological data collection device detects that the first physiological monitoring appliance is decoupled from the attachment port. The portable physiological data collection device subsequently detects that a second different physiological monitoring appliance is communicatively (and potentially also mechanically and/or electrically) coupled to the attachment port. The second different physiological monitoring appliance is also selected from among the plurality of different physiological monitoring appliances. The portable physiological data collection device collects second physiological data from the second physiological appliance. The second physiological data is stored at the storage device.

In response to a triggering event, the portable physiological data collection device establishes a network connection to a designated computer system. Also in response to the triggering event, the portable physiological data collection device transfers any stored physiological data, including the first physiological data and the second physiological data, from the portable physiological data collection device to the designated computer system over the established network connection.

Physiological monitoring appliances can include: EKG monitors, glucometers, bone density scanners, heart rate monitors, scales, blood pressure cuffs, pulse oximeters, thermometers, etc. Collected physiological data can include: Electrocardiography (“EKG”) data, blood glucose data, bone density data, heart rate date, body mass data, blood pressure data, blood oxygen data, temperature data, etc.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out herein. These and other features of the present invention will become more fully apparent from the following description, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates collecting and transferring physiological data.

FIG. 2 illustrates a flow chart of an example method for collecting and transferring physiological data.

FIG. 3 illustrates another example computer architecture that facilitates sharing healthcare information on private collaborative networks.

FIG. 4 illustrates another example computer architecture that facilitates sharing healthcare information on private collaborative networks.

### DETAILED DESCRIPTION

The present invention extends to methods, systems, and computer program products for collecting and transferring physiological data. A portable physiological data collection device collects first physiological data from a first physiological monitoring appliance. The first physiological monitoring appliance communicatively couples (and may also mechanically and/or electrically couple) to an attachment port of the portable physiological data collection device. The first physiological monitoring appliance is selected from among a plurality of different physiological monitoring appliances configured for use with the A portable physiological data collection device. The first physiological data is stored at a storage device.

The portable physiological data collection device detects that the first physiological monitoring appliance is decoupled from the attachment port. The portable physiological data collection device subsequently detects that a second different physiological monitoring appliance is communicatively (and potentially also mechanically and/or electrically) coupled to the attachment port. The second different physiological monitoring appliance is also selected from among the plurality of different physiological monitoring appliances. The portable physiological data collection device collects second physiological data from the second physiological appliance. The second physiological data is stored at the storage device.

In response to a triggering event, the portable physiological data collection device establishes a network connection to a designated computer system. Also in response to the triggering event, the portable physiological data collection device transfers any stored physiological data, including the first physiological data and the second physiological data, from the portable physiological data collection device to the designated computer system over the established network connection.

Physiological monitoring appliances can include: EKG monitors, glucometers, bone density scanners, heart rate monitors, scales, blood pressure cuffs, pulse oximeters, thermometers, etc. Collected physiological data can include: Electrocardiography (“EKG”) data, blood glucose data, bone density data, heart rate date, body mass data, blood pressure data, blood oxygen data, temperature data, etc.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter of this application has been described in language specific to structural features and/or methodological acts, it is to be understood that the subject matter defined herein is not necessarily limited to the specific features or acts described above. Rather, the described features and acts are disclosed as example forms of implementing the embodiments described herein.

Those skilled in the art will appreciate that the invention may be practiced in network computing environments with many types of computer system configurations, including, personal computers, desktop computers, laptop computers, message processors, hand-held devices, portable devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. As used herein, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

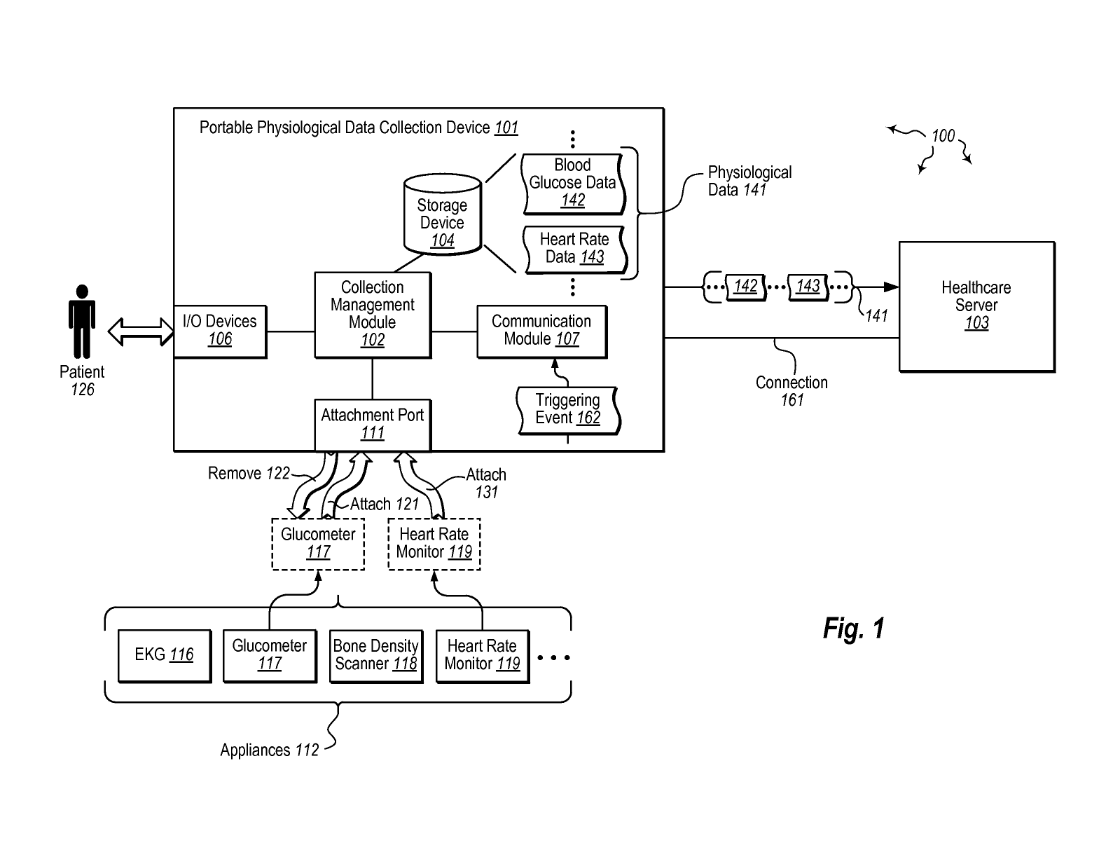

FIG. 1 illustrates an example computer architecture 100 that facilitates collecting and transferring physiological data. Referring to FIG. 1, computer architecture 100 includes portable physiological collection device 101 and healthcare server 103. Portable physiological collection device 101 and healthcare server 103 can be connectable to one another over (or be part of) a network, such as, for example, a Local Area Network (“LAN”), a Wide Area Network (“WAN”), the Internet, or other networks. Accordingly, portable physiological collection device 101 and healthcare server 103 as well as any other connected computer systems and their components, can create message related data and exchange message related data (e.g., Internet Protocol (“IP”) datagrams and other higher layer protocols that utilize IP datagrams, such as, for example, Transmission Control Protocol (“TCP”), Hypertext Transfer Protocol (“HTTP”), Simple Mail Transfer Protocol (“SMTP”), etc.) over the network.

Portable physiological data collection device 101 includes collection management module 102, storage device 104, I/O devices 106, communication module 107, and attachment port 111.

Collection management module 102 is configured to perform a variety of functions. Collection management module 102 can provide a user-interface to a user (e.g., patient 126) through I/O devices 106 (e.g., through a monitor or display). The user can use I/O devices 106 (e.g., a keypad or touch screen) to interact with portable physiological collection device 101 through the user interface. The user interface can be used to provide input to collection management module 102 for configuring portable physiological collection device 101. Configuring portable physiological collection device 101 can include configuring the collection of physiological data, calibrating portable physiological collection device 101, setting triggering events for transferring stored physiological data, etc.

Collection management module 102 is also configured to detect communicative coupling to physiological monitoring appliances at attachment port 111. Detecting a communicatively coupling to a physiological monitoring appliance can include detecting wireless or wired communication from a physiological monitoring appliance. In some embodiments, communicative coupling also includes electrical and/or mechanical coupling of a physiological monitoring appliance to attachment port 111. For example, a physiological monitoring appliance can be “plugged-in” to attachment portion 111. Electrical contacts on the physiological monitoring appliance can be placed in connection with electrical contacts on attachment port 111 to facilitate an electrical coupling between the physiological monitoring device and portable physiological data collection device 101.

When a physiological monitoring appliance is communicatively coupled to attachment port 111, portable physiological collection device 101 changes to the functionality of the coupled physiological monitoring appliance. As depicted, appliances 112 includes EKG 116, glucometer 117, bone density scanner 118 and heart rate monitor 119. Other physiological monitoring appliances, such as, for example, blood pressure cuffs, pulse oximeters, thermometers, scales, etc. can also be used. Collection management module 102 can collect physiological data obtained by a physiological monitoring appliance. For example, collection management module 102 can collect blood glucose data from glucometer 117.

In some embodiments, physiological monitoring appliances include a memory buffer that can store obtained physiological data. Obtained physiological data can be maintained within the physiological monitoring appliance until collection management module 102 collects the physiological data (and even if the physiological monitoring device is decoupled from attachment port 111). In other embodiments, collection management module 102 collects physiological data as the physiological data is obtained by a physiological collection device.

Collection management module 102 can store different types of collected physiological data at storage device 104.

Communication module 107 is configured to establish a connection to an external computer system (e.g., a healthcare system server or a local computer system) in response to a triggering event. A triggering event can be a user entered command, expiration of a timer, coupling a physiological monitoring appliance to attachment port 111, decoupling a physiological monitoring appliance from attachment port 111, etc. Upon detecting a triggering event, communication module 107 establishes a (e.g., LAN and/or WAN) connection to the external computer system. The established connection can include a cellular or TCP/IP connection or other connectivity arrangement. Communication module 107 transfers any stored physiological data to the external computer system over the established connection. When physiological data is successfully transferred, collection management module 102 can remove the physiological data from storage device 104.

In some embodiments, a plurality of different types of physiological data is transferred over an established connection. For example, a patient can use different physiological monitoring appliances to collect various different types of physiological data during a specified time period (e.g., over the course of a day). Any collected physiological data can be transferred when a new time period is to begin (e.g., at midnight each night).

If communication module 107 fails to establish a connection to an external computer system, previously collected physiological data can continue to be stored at storage device 104. When a connection is eventually establish, collected physiological data for multiple time periods can be transferred.

In some embodiments, multiple triggering events can be used to insure that collected physiological data is transferred. For example, an express user command may be a preferred triggering mechanism for establishing a connection and transferring collected physiological data. Portable physiological data collection device 101 can also be configured to automatically establish a connection and transfer collected physiological data at specified times. Thus, even if a user forgets or if communication is not available when a user entered command is received, there is an increased likelihood of transferring collected physiological data to the external computer system.

Attachment port 111 can include electrical connections for electrically coupling to a physiological monitoring appliance. When attached to attachment port 111, the electrical connections electrically couple a physiological monitoring appliance to portable physiological data collection device 101. Physiological data obtained by the physiological monitoring appliance can be transferred to portable physiological data collection device 101 over the electrical connections (e.g., when wired communication is used).

Attachment port 111 can also include mechanical connections for mechanically coupling to a physiological monitoring appliance. When attached to attachment port 111, the mechanical connections mechanically couple a physiological monitoring appliance to portable physiological data collection device 101. The mechanical connections can be used to secure a physiological monitoring appliance at attachment port 111 so that electrical couplings are maintained. The mechanical connections can include a release mechanism for releasing a physiological monitoring appliance from attachment port 111 for removal from portable physiological data collection device 101.

Healthcare server 103 can be an external computer system that shares collected physiological data as well as other healthcare information with family members, friends, healthcare providers, healthcare institutions (hospitals, clinics, skilled care facilities, etc.), laboratories, insurance providers, etc. Healthcare server 103 can share healthcare information in accordance with patient configured rules so that patients have control over dissemination their healthcare information.

In some embodiments, portable physiological data collection device 101 is connectable directly to healthcare server 103. When a connection is established, collected physiological data can be transferred (e.g., over a cellular network) directly to healthcare server 103. In other embodiments, portable physiological data collection device 101 is connectable to a local computer system (e.g., at a patient's residence) that is in turn connected to healthcare server 103. In these alternate embodiments, portable physiological data collection device 101 can transfer collected physiological data to the local computer system. The local computer system can then transfer collected physiological data to healthcare server 103.

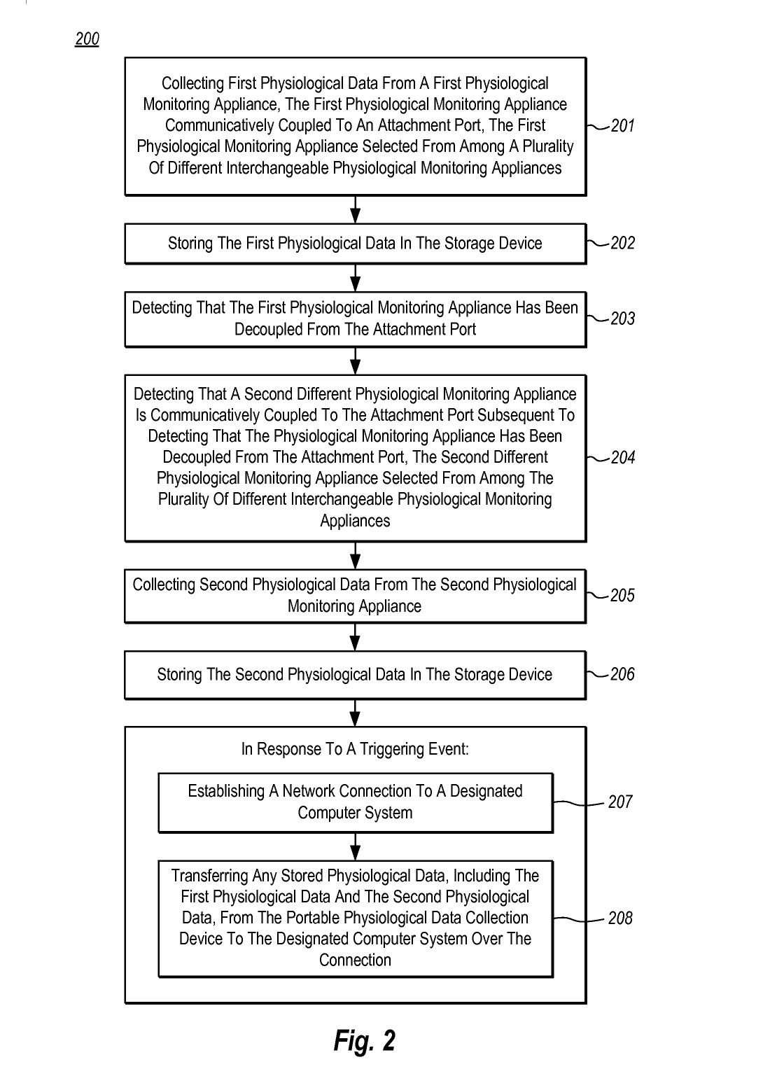

FIG. 2 illustrates a flow chart of an example method 200 for collecting and transferring physiological data. Method 200 will be described with respect to the components and data of computer architecture 100.

Method 200 includes an act of collecting first physiological data from a first physiological monitoring appliance, the first physiological monitoring appliance communicatively coupled to an attachment port, the first physiological monitoring appliance selected from among the plurality of different interchangeable physiological monitoring appliances (act 201). For example, patient 126 can select glucometer 107 from among appliances 112. Patient 126 can attach 121 glucometer 117 to attachment port 111 to communicatively (and potentially also electrically and/or mechanically) couple glucometer 117 to attachment port 111. Alternately, it may be that glucometer 117 was previously coupled to portable physiological data collection device 101. Patient 126 can configure portable physiological data collection 101 (through a user interface and/or using I/O devices 106) to collect blood glucose data from glucometer 117. Patient 126 can use glucometer 117 to obtain blood glucose data 142 (e.g., exposing a sensor to sample of his or her blood). Collection management module 102 can collect blood glucose data 142 from glucometer 117.

Method 200 includes an act of storing the first physiological data in the storage device (act 202). For example, collection management module 102 can store blood glucose data 142 at storage device 104.

Method 200 includes an act of detecting that the first physiological monitoring appliance has been decoupled from the attachment port (act 203). For example, patient 126 can remove 122 glucometer 117 from attachment port 111. Collection management module 102 can detect that glucometer 117 is no longer communicatively (or electrically and/or mechanically) coupled to attachment port 111.

Method 200 includes an act of detecting that a second different physiological monitoring appliance is communicatively coupled to the attachment port subsequent to detecting that the first monitoring appliance has been decoupled from the attachment port, the second different physiological monitoring appliance selected from among the plurality of different interchangeable physiological monitoring appliances (act 204). For example, subsequent to detecting that glucometer 117 has been decoupled, patient 126 can select heart rate monitor 119 from among appliances 112. Patient 126 can attach 131 heart rate monitor 119 to attachment port 111. Collection management module 102 can detect that heart rate monitor 119 is communicatively (and possibly also electrically and/or mechanically) coupled to attachment port 111.

Method 200 includes an act of collecting second physiological data from the second physiological monitoring appliance (act 205). For example, patient 126 can configure portable physiological data collection device 101 (through a user interface and/or using I/O devices 106) to collect heart rate data from heart rate monitor 119. Patient 126 can use heart rate monitor 119 to obtain heart rate data 143 (e.g., exposing a sensor to his or her heartbeat). Collection management module 102 can collect heart rate data 143 from heart rate monitor 119.

Method 200 includes an act of storing the second physiological data in the storage device (act 206). For example, collection management module 102 can store heart rate data 143 in storage device 104.

Acts 203-206 can be repeated as appropriate to collect other types of physiological data, such as, for example, Electrocardiography (“EKG”) data, weight data, temperature data, body mass data, oxygen saturation data, blood pressure data, and bone density data, etc., for patient 126.

Method 200 includes, in response to a triggering event, an act of establishing a network connection to a designated computer system (act 207). For example, in response to trigger event 162 (e.g., a user command, expiration of a timer, etc.), communication module 107 can establish a network connection 161 between portable physiological data collection device 101 and healthcare server 103.

Method 200 includes, in response to the triggering event, transferring any stored physiological data, including the first physiological data and the second physiological data, from the portable physiological data collection device to the designated computer system over the network connection (act 208). For example, communication module 107 can transfer physiology data 141, including blood glucose data 142 and heart rate data 143, from portable physiological data collection device 101 to healthcare server 103 over connection 161. Physiological data 141 can include blood glucose data 142 and heart rate data 143, as well as any physiological data collected by other of appliances 112.

Accordingly, a plurality of different types of physiological data can be collected by and stored at portable physiological data collection device 101. The collected and stored physiological data can be transferred to external computer systems to make the physiological data accessible to entities involved in the care of patient 126.

As described, external computer systems, such as, for example, healthcare server 103, can share healthcare information in accordance with patient configured rules so that patients have control over dissemination their healthcare information.

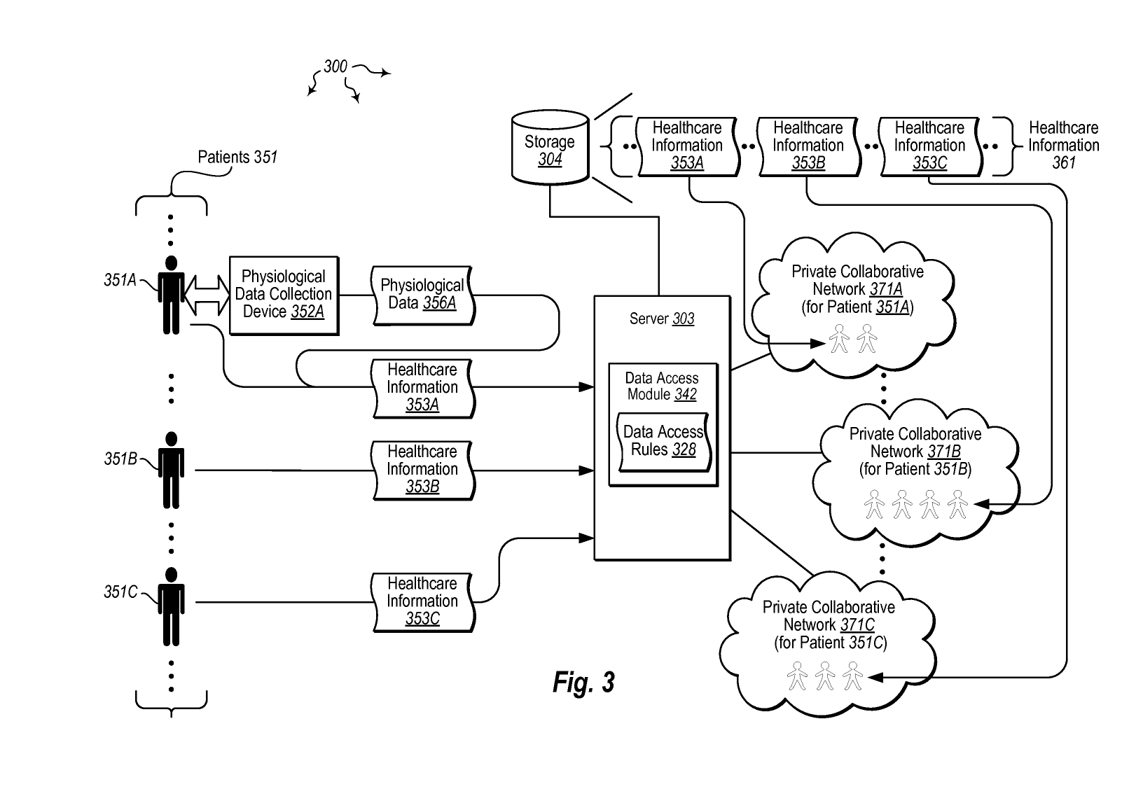

FIG. 3 illustrates an example computer architecture 300 that facilitates sharing healthcare information on private collaborative networks. Referring to FIG. 3, computer architecture 300 includes server 303 and storage 304. Each of the depicted components is connected to one another over (or is part of) a network, such as, for example, a Local Area Network (“LAN”), a Wide Area Network (“WAN”), the Internet or other networks. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Server 303 includes data access module 342. Data access module 342 is configured to control third-party access to patient healthcare information 361 stored in storage 304. Healthcare information 361 can include physiological data, prescription medicine data, medicine intake data, electronic medical record data, etc. Patient healthcare information can originate from a variety of sources, including: the patient, healthcare providers, healthcare institutions, pharmacies, etc. Any of these sources can provide healthcare information for patients 351 to server 303. For example, these sources can provide healthcare information 353A, 353B, and 353C for patients 351A, 351C, and 351C respectively.

In some embodiments, physiological data collection devices are also used to provide healthcare information for a patient. For example, physiological data collection device 352A can collect physiological data 356A (e.g., blood glucose data, heart rate data, Electrocardiography (“EKG”) data, weight data, temperature data, body mass data, and bone density data, etc.) for patient 351A. Physiological data 156A can be included with healthcare information 353A for patient 351A

Provided healthcare information, including healthcare information 353A, 353B, and 353C, can be stored in storage 304.

Data access module 342 maintains data access rules 328. Data access rules 328 can contain data access rules for a plurality of patients, including patients 351. For each of the plurality of patients, data access rules 328 define what portion of the patient's healthcare information 361 is accessible to one or more designated entities. For example, for each of patients 351A, 351B, and 351C, data access rules 328 can define what portions of healthcare information 353A, 353B, and 353C respectively are available to designated entities. Designated entities can include: family members, friends, healthcare providers, healthcare institutions (hospitals, clinics, skilled care facilities, etc.), laboratories, insurance providers, or other interested or necessary parties.

Patients can interact with server 303 to control access to their healthcare information. Server 303 can include a patient interface (e.g., a Web based patient user interface) that patients can use to configure rules for accessing their healthcare information. Patients can use the patient interface to give different designated entities access to different portions of their healthcare information. Setting up access to a patient's healthcare information essentially defines a private collaborative network for the patient. For example, patient 351A can configure access to healthcare information 353A to define private collaborative network 371A. Similarly, patient 351B can configure access to healthcare information 353B to define private collaborative network 371B. Likewise, patient 351C can configure access to healthcare information 353C to define private collaborative network 371C.

Within a private collaborative network, designated entities can collaborate, based on healthcare information available to them, to assist with a patient's care. For example, within private collaborative network 371A, a family member and doctor can collaborate to provide care for patient 351A, based on portions of healthcare information 353A available to each of the family member and the doctor.

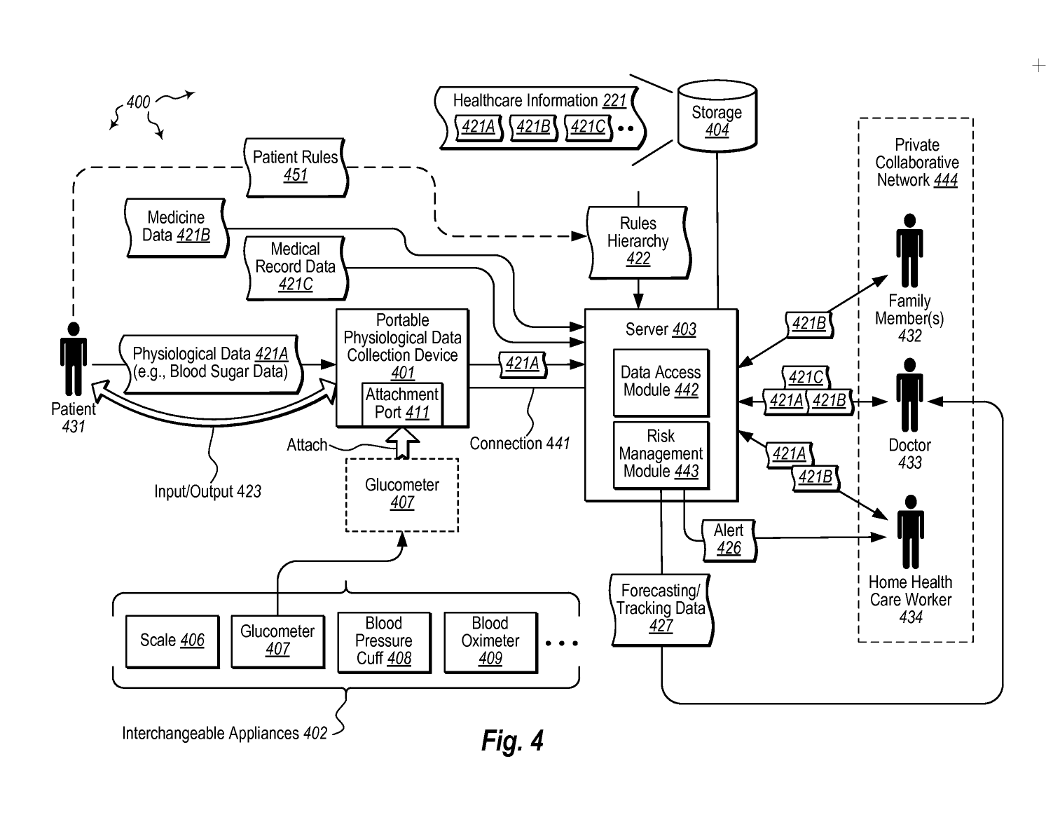

FIG. 4 illustrates an example computer architecture 400 that facilitates sharing healthcare information on private collaborative networks. Referring to FIG. 4, computer architecture 400 includes portable physiological collection device 401, server 403, and storage 404. Each of the depicted devices and components is connected to one another over (or is part of) a network, such as, for example, a Local Area Network (“LAN”), a Wide Area Network (“WAN”), the Internet or other networks. Accordingly, each of the depicted computer systems as well as any other connected computer systems and their components, can create message related data and exchange message related data (e.g., Internet Protocol (“IP”) datagrams and other higher layer protocols that utilize IP datagrams, such as, for example, Transmission Control Protocol (“TCP”), Hypertext Transfer Protocol (“HTTP”), Simple Mail Transfer Protocol (“SMTP”), etc.) over the network.

As depicted, server 403 includes data access module 442 and risk management module 443. Data access module 442 is configured to control third-party access to patient healthcare information stored in storage 404. Risk management module 443 is configured to analyze patient healthcare information. Risk management module 443 can determine if healthcare information for a patient satisfies any risk management criteria for the patient. Risk management module 443 can automatically send a notification to a corresponding specified entity when it is determined that risk management criteria is satisfied. Risk management module 443 can also provide forecasting/tracking data for a patient. Forecasting/tracking data can be used to prevent a risk management event prior to occurrence. For example, if a diabetic patient's blood sugar has been trending up for some period of time, the patient's insulin can be increased to prevent hyperglycemic related conditions.

In general, storage 404 can store healthcare information for patients. For example, storage 404 can store healthcare information 421 for patient 431. Healthcare information 421 includes physiological data 421A, medicine data 421B, and medical record data 421C. Medicine data 421B can include prescription medicine data and/or medicine intake data. In some embodiments, physiological data 421A can be collected by portable physiological collection device 401.

Portable physiological collection device 401 includes attachment port 411. Attachment port 411 can accept any of a variety of interchangeable appliances 402 for collecting different types of physiological data, such as, for example, electrocardiogram data, blood sugar data, bone density data, heart rate data, weight data, temperature data, oxygen saturation data, blood pressure data, etc. As depicted, interchangeable appliances 402 can include scale 406, glucometer 407, blood pressure cuff 408, and pulse oximeter 409. When physiological monitoring appliance is communicatively (and potentially also mechanically and/or electrically) coupled to attachment port 411, portable physiological collection device 401 changes to the functionality of the coupled physiological monitoring appliance. For example, when glucometer 407 is attached to attachment port 411, portable physiological collection device 401 gains the ability to obtain blood sugar data for a patient (e.g., patient 431).

Portable physiological data collection device 401 can also include a processor, system memory, a storage device, a network interface, and a user interface. Computer-executable instructions can run on the processor to implement general and/or special purpose processing capabilities. Implemented processing capabilities can include obtaining physiological data from a physiological monitoring appliance, storing obtained physiological data (e.g., in the storage device), and providing stored physiological data over a connection to a server. Through the user interface, a patient can calibrate portable physiological data collection device 401 and can configure portable physiological data collection device 401 to collect physiological data, download physiological data from a physiological monitoring appliance to system memory and/or the storage device, and transfer physiological data to a server.

Portable physiological collection device 401 can be (e.g., intermittently) connected to server 403 via connection 441. Connection 441 can be via cellular, TCP/IP or other connections or a combination of connections. During connection 441, portable physiological collection device 401 can use the network interface to transfer collected physiological data to server 403.

In general, access to a patient's healthcare information can be defined in rules hierarchy 422. For example, rules hierarchy 422 can include data access rules as well as risk management criteria for a plurality of patients, including patient 431. A patient can define individual patient rules to control access to his or her healthcare information. Definition of patient rules essentially defines a private collaborative network for the patient.

For example, patient 431 can define patient rules 451 to control access to healthcare information 421. Patient rules 451 can be merged into rules hierarchy 422. Patient rules 451 can define private collaborative network 444 that permits family member(s) 432 to access to medicine data 421B, permits doctor 423 to access physiological data 421A, medicine data 421B, and medical record data 421C, and permits home healthcare worker 434 to access physiological data 421A and medicine data 421B. As such, family member(s) 432, doctor 433, and home healthcare worker 434 can collaborate in the care and treatment of patient 431 to the extent they are aware of patient 431's healthcare information. For example, family member(s) 432 can determine if patient 431 has taken medication and, if not, can contact home healthcare worker 434 to be sure medication is administered.

Risk management rules in rules hierarchy 422 can be defined by the owner of server 403 and/or by patient healthcare providers. Since patients can have different conditions and can manifest symptoms of the same conditions in different ways, healthcare providers can configure risk management criteria on a per patient basis. For example, doctor 433 can configure risk management criteria for patient 431 based on the medical history of patient 431.

Risk management module 443 can monitor healthcare information 421. If healthcare information 421 ever satisfies the configured risk management criteria, alert 426 can be automatically sent to home healthcare worker 434. Based on the healthcare information 421, risk management module 443 can also provide forecasting/tracking data 427 (for patient 431) to doctor 433.

The present invention may be embodied in other specific forms without departing from its spirit or essential characteristics. The described embodiments are to be considered in all respects only as illustrative and not restrictive. All changes which come within the meaning and range of equivalency of the described embodiments are to be embraced within their scope.

What is claimed:

1. At a mobile physiological data collection device, the mobile physiological data collection device including an attachment port, a storage device, and communication module, the attachment port for accepting any of a plurality of different interchangeable physiological monitoring attachments, the storage device for storing collected physiological data, the communication module for transferring collected physiological data to other computer systems, a method for collecting and transferring physiological data for an individual, the method comprising:
an act of collecting first physiological data from a first physiological monitoring attachment, the first physiological monitoring attachment mechanically and electrically coupled to the attachment port, the first physiological monitoring attachment selected from among the plurality of different interchangeable physiological monitoring attachments;
an act of storing the first physiological data in the storage device;
an act of detecting that the first physiological monitoring attachment has been decoupled from the attachment port;
an act of detecting that a second different physiological monitoring attachment is mechanically and electrically coupled to the attachment port subsequent to detecting that the physiological monitoring attachment has been decoupled from the attachment port, the second different physiological monitoring attachment selected from among the plurality of different interchangeable physiological monitoring attachments;
an act of collecting second physiological data from the second physiological monitoring attachment;
an act of storing the second physiological data in the storage device; and
in response to a triggering event:
an act of establishing a network connection to a designated computer system; and
an act of transferring any stored physiological data, including the first physiological data and the second physiological data, from the mobile physiological data collection device to the designated computer system over the network connection.

2. The method as recited in claim 1, wherein the act of collecting first physiological data comprises an act of collecting one of: electrocardiogram data, blood sugar data, bone density data, heart rate data, weight data, temperature data, blood oxygen data, or blood pressure data.

3. The method as recited in claim 1, wherein the act of storing the first physiological data in the storage device comprises an act of storing one of: electrocardiogram data, blood sugar data, bone density data, heart rate data, weight data, temperature data, blood oxygen data, or blood pressure data.

4. The method as recited in claim 1, wherein the act of detecting that a second different physiological monitoring attachment is mechanically and electrically coupled to the attachment port comprises an act of detecting that one of: an EKG, a glucometer, a bone density scanner, a heart rate monitor, a scale, a thermometer, a blood pressure cuff, or a blood oximeter is mechanically and electrically coupled to the attachment port.

5. The method as recited in claim 1, further comprising an act of detecting the triggering event, the trigger event selected from among: removing an interchangeable attachment from the attachment port, receiving an express user command, or expiration of a timer.

6. The method as recited in claim 5, wherein an act of establishing a network connection to a designated computer system comprises establishing one of a cellular connection or a TCP/IP connection to the designated computer system.

7. The method as recited in claim 5, wherein an act of establishing a network connection to a designated computer system comprises establishing a network connection to a server that shares patient healthcare information between designated entities in patient configured private collaborative networks.

8. The method as recited in claim 5, wherein an act of transferring any stored physiological data comprises transferring any stored physiological data over one of a cellular connection or a TCP/IP connection.

9. The method as recited in claim 5, wherein an act of transferring any stored physiological data comprises transferring any stored physiological data to a server that shares patient healthcare information between designated entities in patient configured private collaborative networks.

10. A computer program product for use at a mobile physiological data collection device, the mobile physiological data collection device including an attachment port, a storage device, and communication module, the attachment port for accepting any of a plurality of different interchangeable physiological monitoring attachments, the storage device for storing collected physiological data, the communication module for transferring collected physiological data to other computer systems, the computer program product for implementing a method for collecting and transferring physiological data for an individual, the computer program product comprising one or more storage devices having sored thereon computer-executable instructions that, when executed at a processor, cause the mobile physiological data collection device to perform the method, including the following:
collect first physiological data from a first physiological monitoring attachment, the first physiological monitoring attachment mechanically and electrically coupled to the attachment port, the first physiological monitoring attachment selected from among the plurality of different interchangeable physiological monitoring attachments;
an store the first physiological data in the storage device;
detect that the first physiological monitoring attachment has been decoupled from the attachment port;
detect that a second different physiological monitoring attachment is mechanically and electrically coupled to the attachment port subsequent to detecting that the physiological monitoring attachment has been decoupled from the attachment port, the second different physiological monitoring attachment selected from among the plurality of different interchangeable physiological monitoring attachments;
collect second physiological data from the second physiological monitoring attachment;
storing the second physiological data in the storage device; and in response to a triggering event:
establish a network connection to a designated computer system; and
transfer any stored physiological data, including the first physiological data and the second physiological data, from the mobile physiological data collection device to the designated computer system over the network connection.

11. The computer program product as recited in claim 10, wherein computer-executable instructions that, when executed, cause the mobile physiological data collection device to collect first physiological data comprise computer-executable instructions that, when executed, cause the mobile physiological data collection device to collect one of: electrocardiogram data, blood sugar data, bone density data, heart rate data, weight data, temperature data, blood oxygen data, or blood pressure data.

12. The computer program product as recited in claim 10, wherein computer-executable instructions that, when executed, cause the mobile physiological data collection device to store the first physiological data in the storage device comprise computer-executable instructions that, when executed, cause the mobile physiological data collection device to store one of: electrocardiogram data, blood sugar data, bone density data, heart rate data, weight data, temperature data, blood oxygen data, or blood pressure data.

13. The computer program product as recited in claim 10, wherein computer-executable instructions that, when executed, cause the mobile physiological data collection device to detect that a second different physiological monitoring attachment is mechanically and electrically coupled to the attachment port comprise computer-executable instructions that, when executed, cause the mobile physiological data collection device to detect that one of: an EKG, a glucometer, a bone density scanner, a heart rate monitor, a scale, a thermometer, a blood pressure cuff, or a blood oximeter, is mechanically and electrically coupled to the attachment port.

14. The computer program product as recited in claim 10, further comprising computer-executable instructions that, when executed, cause the mobile physiological data collection device to detect the triggering event, the trigger event selected from among: removing an interchangeable attachment from the attachment port, receiving an express user command, or expiration of a timer.

15. The computer program product as recited in claim 14, wherein computer-executable instructions that, when executed, cause the mobile physiological data collection device to establish a network connection to a designated computer system comprise computer-executable instructions that, when executed, cause the mobile physiological data collection device to establish one of a cellular connection or a TCP/IP connection to the designated computer system.

16. The computer program product as recited in claim 14, wherein computer-executable instructions that, when executed, cause the mobile physiological data collection device to establish a network connection to a designated computer system comprise computer-executable instructions that, when executed, cause the mobile physiological data collection device to establish a network connection to a server that shares patient healthcare information between designated entities in patient configured private collaborative networks.

17. The computer program product as recited in claim 14, wherein computer-executable instructions that, when executed, cause the mobile physiological data collection device to transfer any stored physiological data over the network connection comprise computer-executable instructions that, when executed, cause the mobile physiological data collection device to transfer any stored physiological data over one of: a cellular connection or a TCP/IP connection.

18. The computer program product as recited in claim 14, wherein computer-executable instructions that, when executed, cause the mobile physiological data collection device to transfer any stored physiological data over the network connection comprise computer-executable instructions that, when executed, cause the mobile physiological data collection device to transfer any stored physiological data to a server that shares patient healthcare information between designated entities in patient configured private collaborative networks.

19. A mobile physiological data collection device, the mobile physiological data collection device comprising:
one or more processors;
system memory;
an attachment port, the attachment port configured to mechanically and electrically couple to any of a plurality of different physiological monitoring attachments, each different physiological monitoring attachment configured to collect a different type of physiological data;
a communication module, the communication module configured to, in response to a triggering event:
establish a network connection to a designated computer system; and
transfer different types of stored physiological data from the mobile physiological data collection device to the designated computer system over the network connection;
one or more storage devices, the one or more storage devices:
configured to store different types of collected physiological data obtained from physiological monitoring attachments coupled to the attachment port; and
having stored thereon computer-executable instructions representing a collection management module, the collection management module configured to:
detect when one of the plurality of different physiological monitoring attachments is coupled to the attachment port;
collect physiological obtained by the physiological monitoring attachment; and
store the physiological data at the one or more storage devices.

20. The mobile physiological data collection device as recited in claim 19, wherein the communication module being configured to establish a network connection to a designated computer system comprises the communication module being configured to establish one of: a cellular connection or a TCP/IP connection to a server that shares patient healthcare information between designated entities in patient configured private collaborative networks; and
wherein the communication module being configured to transfer different types of stored physiological data from the mobile physiological data collection device to the designated computer system over the network connection comprises the communication module being configured to transfer types of stored physiological data from the mobile physiological data collection device to the server over the establish one of: the cellular connection or the TCP/IP connection.
